(19) United States
(12) Patent Application Publication
(10) Pub. No.: US 2026/0329785 A1
(43) Pub. Date: Oct. 22, 2026

(54) Multi-Lane Memory Card

(71) Applicant: Sandisk Technologies, Inc., Milpitas, CA (US)

(72) Inventors: Raghavan Nagarajan, Karnataka (IN); Hariharapandian S, Karnataka (IN)

(73) Assignee: Sandisk Technologies, Inc., Milpitas, CA (US)

(21) Appl. No.: 19/182,865

(22) Filed: Apr. 18, 2025

(51) Int. Cl. G06F 13/16; G06F 13/42

(52) U.S. Cl. CPC G06F 13/1684; G06F 13/4221

(57) ABSTRACT

A memory card includes a substrate having a first side and a second side opposite the first side. A memory device is coupled to one of the first and second sides of the substrate. First and second lanes of contact pads are disposed on the first side of the substrate. A third lane of contact pads is disposed on the second side of the substrate. A casing encloses at least a portion of the substrate and has a first opening exposing the first and second lanes of contact pads and a second opening exposing the third lane of contact pads. By including the third lane of contact pads, data transfer speeds of the memory card may be significantly increased, real-time performance may be optimized, and/or a scalable solution for next-generation data-intensive applications may be achieved.

### TECHNICAL FIELD

The present disclosure generally relates to memory cards and, in some embodiments, to multi-lane memory cards.

### BACKGROUND

The present technology relates to memory cards and their operation. Semiconductor memory devices have become more popular for use in various electronic devices. For example, non-volatile semiconductor memory is used in cellular telephones, digital cameras, personal digital assistants, mobile computing devices, non-mobile computing devices and other devices (host devices). A memory device may be in the form of a memory card that is configured to be removably coupled to host devices using an interface. For example, pads on a memory card may physically contact and electrically connect with corresponding host contacts of a host device. These connections enable power and data transfer between the memory card and host device. An interface may be defined by a standard that enables a memory card to be coupled to any host device that complies with the same standard.

As data-intensive applications continue to evolve, the demand for high-speed data transfer and real-time processing has grown. Current single-channel (1CH) memory cards, such as Secure Digital (SD) and SD Express cards, while widely used, can impose constraints on data transfer speed due to their bandwidth and single-stream data handling capabilities. Traditional 1CH SD Express cards operate with a single PCIe lane, which can limit the ability to simultaneously process multiple data streams. This is particularly relevant where continuous high-speed data access is required, such as burst photography, high-frame-rate video recording, and real-time industrial data logging. As such, there is a need for a memory card that supports higher data throughput, reduced latency, and improved parallel processing while being backwards compatible with legacy standard interfaces.

### SUMMARY

In one embodiment there is a memory card including a substrate having a first side and a second side opposite the first side, a memory device coupled to one of the first and second sides of the substrate, a first lane of contact pads and a second lane of contact pads disposed on the first side of the substrate, a third lane of contact pads disposed on the second side of the substrate, and a casing enclosing at least a portion of the substrate therein and having a first opening exposing the first and second lanes of contact pads and a second opening exposing the third lane of contact pads.

In some embodiments, the third lane includes at least one SD interface pad. In some embodiments, the first lane provides a primary SD interface and the third lane provides a secondary SD interface. In some embodiments, the memory device includes a controller configured to selectively activate at least one of the first lane and the third lane based on a corresponding interface of a host device that the memory card is connected to. In some embodiments, the third lane includes two PCIe lanes. In some embodiments, the second lane provides a first PCIe lane and the third lane includes a second PCIe lane and a third PCIe lane. In some embodiments, the memory card further includes a controller configured to activate at least one of the first lane and the third lane when the memory card is connected to a host device. In some embodiments, the third lane is disposed on the second side of the substrate in a mirrored position with respect to a position of the first lane on the substrate. In some embodiments, the casing has a thickness of about 2.1 mm.

In another embodiment there is a memory card including a substrate having a first side and a second side opposite the first side, a memory device including a memory die and a memory controller, the memory device electrically and mechanically connected to the substrate on one of the first and second sides, a first lane of contact pads and a second lane of contact pads electrically and mechanically connected to the substrate at the first side, a third lane of contact pads electrically and mechanically connected to the substrate at the second side, and a casing enclosing at least a portion of the substrate and memory device therein and having a first opening at the first side exposing the first and second lanes of contact pads and a second opening at the second side exposing the third lane of contact pads.

In some embodiments, the controller is configured to selectively activate at least one of the first lane and the third lane based on a corresponding interface of a host device that the memory card is connected to. In some embodiments, the third lane includes at least one SD interface pad. In some embodiments, the first lane provides a primary SD interface and the third lane provides a secondary SD interface. In some embodiments, the third lane includes two PCIe lanes. In some embodiments, the second lane provides a first PCIe lane and the third lane includes a second PCIe lane and a third PCIe lane. In some embodiments, the third lane is disposed on the second side of the substrate in a mirrored position with respect to a position of the first lane on the substrate. In some embodiments, the casing has a thickness of about 2.1 mm. In some embodiments, the memory card is a secure digital card.

In another embodiment there is a memory card including a substrate means for providing electrical interconnections between electrical components coupled to the substrate means, a storage means for storing an amount of data, a first lane of electrical contact means and a second lane of electrical contact means each for providing electrical interface between the storage and a host device, the first and second lanes of electrical contact means disposed on a first side of the substrate means, a third lane of electrical contact means for providing electrical interface between the storage means and a host device, the third lane of electrical contact means disposed on a second side of the substrate opposite the first side, and a casing means for enclosing at least a portion of the substrate means and storage means.

In some embodiments, the memory card further includes a memory control means for controlling operation of the storage means, the memory control means configured to selectively active the first, second and third electrical contact means based on a connection of the memory card to the host device.

### BRIEF DESCRIPTION OF THE DRAWINGS

The following detailed description of embodiments of the card will be better understood when read in conjunction with the appended drawings of exemplary embodiment. It should be understood, however, that the invention is not limited to the precise arrangements and instrumentalities shown.

In the drawings:

FIG. 1A is a bottom view of a memory card in accordance with an exemplary embodiment of the present invention;

FIG. 1B is a top view of the memory card of FIG. 1A;

FIG. 2 is a side cross sectional view of the memory card of FIG. 1A;

FIG. 3 is a system diagram of a memory card in accordance with a second exemplary embodiment of the present invention;

FIG. 4 is a system diagram of a memory card in accordance with a third exemplary embodiment of the present invention; and

FIG. 5 is a system diagram of a memory card in accordance with a fourth exemplary embodiment of the present invention.

### DETAILED DESCRIPTION

The present technology relates to memory cards and their operation. Semiconductor memory devices have become more popular for use in various electronic devices. For example, non-volatile semiconductor memory is used in cellular telephones, digital cameras, personal digital assistants, mobile computing devices, non-mobile computing devices and other devices (host devices). A memory device may be in the form of a memory card that is configured to be removably coupled to host devices using an interface. For example, pads on a memory card may physically contact and electrically connect with corresponding host contacts of a host device. These connections enable power and data transfer between the memory card and host device. An interface may be defined by a standard that enables a memory card to be coupled to any host device that complies with the same standard.

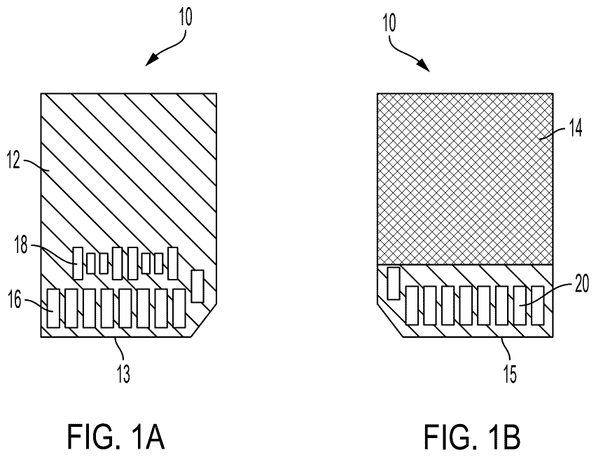

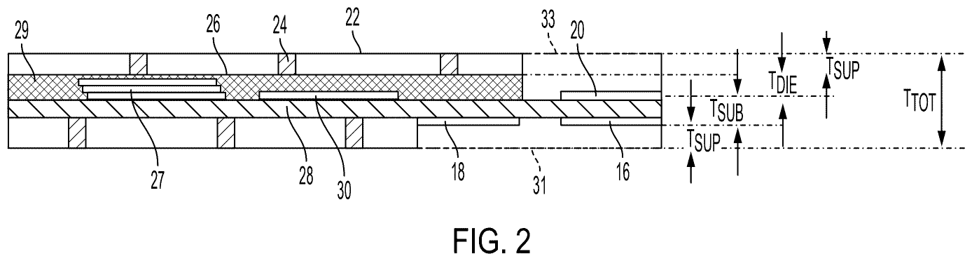

Referring to the drawings in detail, wherein like reference numerals indicate like elements throughout, there is shown in FIGS. 1A-2 a memory card, generally designated 10, in accordance with an exemplary embodiment of the present invention. In some embodiments, the memory card 10 is a semiconductor device package. In some embodiments, the memory card 10 is a non-volatile memory card. In some embodiments, the memory card 10 is a NAND flash memory card. In some embodiments, the memory card 10 is a NAND flash memory card. In some embodiments, the memory card 10 is a SD card or a multi-media card (MMC). In some embodiments, the memory card 10 is a SD, SDHC, SDXC, microSD card. The memory card 10 may have two sides, a first side 12 and a second side 14. The first side 12 may be a bottom side and the second side 14 may be a top side. The first side 12 may be a top surface that is generally flat or planar. The second side 14 may be a bottom surface that is generally flat or planar. As described in more detail below, the first side 12 and the second side 14 may be defined by a casing 22 configured to house components of the memory card 10. In some embodiments, the first side 12 is defined by the top surface of the casing 22 and the second side 14 is defined by the bottom surface of the casing 22.

The memory card 10 may include a plurality of electrical contact pads arranged in one or more lanes accessible at an outer surface of the memory card 10. The electrical contact pads may be electrical interface means that allow for electrical communication between the memory card and an external device (e.g., a host device, a computing device, a smartphone, tablet, computer, camera). The memory card 10 may include a first lane 16, a second lane 18, and a third lane 20 of contact pads configured to act as interfaces for electrical signals transmitted to and from the memory card 10. The first, second and third lanes 16, 18, 20 may each comprise one or more electrical contact pads. In some embodiments, the number of contact pads included in a lane corresponds to the type of lane that is desired. For example, a 4-bit mode lane may include a number of electrical contact pads corresponding to four data lines (e.g., DAT0-DAT3), a command line (e.g., CMD), a ground line (e.g., VSS), a power line (e.g., VDD), and a clock function line (e.g., CLK). In some embodiments, the electrical contact pads of a respective lane 16, 18, 20 intersect a common axis. The lanes 16, 18, 20 of electrical contact pads may extend generally along a width of the memory card 10.

In some embodiments, the first lane 16, second lane 18 and third lane 20 may be non-continuous. For example, the first lane 16, second lane 18, and third lane 20 may be positioned apart from each other on the memory card 10 and/or include electrical contact pads connected to different electrical pathways. Each of first lane 16, second lane 18, and third lane 20 may have its own electrical path separate from the others. In some embodiments, one or more of the first lane 16, second lane 18, and third lane 20 share an electrical path. In some embodiments, the first lane 16, second lane 18, and third lane 20 are spaced apart from each other on the memory card 10 by dividers. The casing 22 may define dividers that extend between adjacent lanes 16, 18, 20 and/or the electrical contact pads thereof. The casing 22 may include portions that extend between the one or more contact pads of the first lane 16, second lane 18, and third lane 20 such that the space between the pads is covered by the casing 22 while the pads themselves are not. The casing 22 may define a plurality of openings through which the electrical contact pads of lanes 16, 18, and/or 20 are exposed.

Referring to FIG. 2, the memory card 10 may be configured to include the third lane 20 on the second side 14 thereof while ensuring compatibility with existing devices. The memory card 10 may include a casing 22, supports 24 positioned within the casing 22 to provide structural integrity, a memory device 26, and a substrate 28. The casing 22 may extend a length of the memory card 10 along a longitudinal axis. The casing 22 may form a protective outer shell of the memory card 10. In some embodiments, the casing 22 is comprised of a generally rigid polymer or plastic material. In some embodiments, the memory device 26 includes a memory die 27 for storing data. The memory die 27 may generally be a storage means for providing an amount of data storage. In some embodiments, the memory die 27 is a non-volatile memory such as, but not limited to, a NAND die. The memory device 26 may include a plurality of memory dies 27 forming one or more stacks. In some embodiments, the memory device 26 includes a controller 30 configured to route electrical communications to and from the memory dies 27 and control the operations thereof. The controller 30 may generally be a memory controlling means for controlling operations of the memory dies 27. In some embodiments, the memory dies 27 and controller 30 are encapsulated within a molding compound 29 (e.g., an epoxy molding compound (EMC), another molding compound known to those in the art). In some embodiments, the controller 30 may be, for example, a controller die, an application-specific integrated circuit (ASIC) die, or other integrated circuit (IC) die.

The substrate 28 may be a mechanical base support for the memory device 26, lanes 16, 18, 20, supports 24 and casing 22 and an electrical interface (e.g., electrical circuit) that provides access to the memory device 26. For example, the substrate 28 may include one or more electrically conductive layers/traces disposed therein, including at least one layer for routing data using conductive (e.g., copper) traces, a ground layer, and/or a power layer. In some embodiments, the substrate 28 includes

The substrate 28 may have two sides, a first side 40 and a second side 42. The first side 40 may be a bottom side and the second side 42 may be a top side. The first side 40 may be a top surface that is generally flat. The second side 42 may be a bottom surface that is generally flat. In some embodiments, the first side 40 is the top side and the second side 42 is the bottom side.

In some embodiments, the substrate 28 electrically connects the pads 16, 18, 20 to memory device 26. For example, the substrate 28 includes electrical traces connecting the first lane 16, second lane 18, and third lane 20 to the memory controller. The controller 30 may be configured to control the transfer of data and/or power to and from the memory device 26. The memory device 26 may be on a single side of the substrate 28. Only one side of the substrate 28 may have the memory device 26 coupled thereto.

The memory device 26 may be disposed within the casing 22 and may extend at least partially along the length of the memory card 10. The memory device 26 may be mounted to the substrate 28 and may extend along a portion of the length of the substrate 28. In some embodiments, the substrate 28 extends substantially along the length of the memory card 10. The substrate 28 and the memory device 26 may be electrically and/or mechanically connected together. In some embodiments, the casing 22 is coupled to the substrate 28. The casing 22 may include a first opening 31 defined on the first side 12 and a second opening 33 defined on the second side 14 (generally illustrated by the broken lines in FIG. 2) through which the lanes 16, 18, 20 are accessible. The first opening 31 may be configured to expose the first lane 16 and the second lane 18. The second opening 33 may be configured to expose the third lane 20. The supports 24 may be disposed between the casing 22 and the substrate 28 on the first side 12. In some embodiments, the supports 24 may be disposed between the casing 22 and the substrate 28 on the second side 14. The supports 24 may be disposed between the casing 22 and the memory device 26 on the second side 14. In some embodiments, the supports 24 may be disposed between the casing 22 and the memory device 26 on the first side 12.

Inclusion of the third lane 20 on the second side 14 may be facilitated by configuring the memory device 26 to extend less than the length of the memory card 10, creating an exposed position of the substrate 28 without exceeding the industry-standard SD card thickness. In some embodiments, the memory device 26 extends to or near an end of the substrate 28 opposite the end where pads 16, 18, 20 are located. Since the substrate 28 contains copper layers on both of its sides, the second side 14 is selectively opened only in areas where the third lane 20 are placed, while the rest remains covered to prevent unintended exposure. The third lane 20 may mirror a configuration of one or the first lane 16 or the second lane 18. As shown in FIG. 2, the third lane 20 may be vertically aligned with the first lane 16 on the substrate 28.

The memory card 10 may be shaped and sized according to industry standards. In embodiments where the device package is a SD card, the substrate 28 may have a thickness T_{S} of approximately 0.21 mm, but thickness may depend on design constraints, such as mold thickness and mold-to-plastic gap. In some embodiments, the substrate 28 has a thickness T_{SUB} of at least approximately 0.8 mm to provide mechanical strength while maintaining electrical performance. In some embodiments, the substrate 28 has a thickness T_{SUB} of between about 90 micrometers to about 210 micrometers. The supports 24 on the first side 12 may have a thickness T_{SUP} of approximately 0.7 mm. The supports 24 on the second side 14 may have a thickness of approximately 0.2 mm. In some embodiments, the supports 24 on the second side 14 have a thickness of between about 0.2 mm to about 0.4 mm. The memory device 26 may have a thickness T_{DIE} of approximately 0.99 mm. In some embodiments, the memory device 26 has a thickness T_{DIE} of between about 0.8 mm to about 1.0 mm.

In some embodiments, the substrate 28 may be a printed circuit board (PCB) including memory device 26. The substrate 28 and the memory device 26 may be encapsulated within a molding compound.

The first side 12 of the memory card 10 may include the first lane 16 of electrical contact pads disposed thereon in accordance with one or more industry standards for SD cards. The first lane 16 may include a plurality of gold-plated SD interface pads. The first lane 16 may provide compatibility with legacy SD hosts and allow operation within standard SD communication protocols. In some embodiments, the electrical contact pads of the first lane 16 are SD express interface pads. The first side 12 of the memory card 10 may include the second lane 18 disposed thereon. The second lane 18 may be gold-plated SD Express interface pads. The second lane 18 may facilitate high-speed PCIe-based communication. In some embodiments, the second lane 18 are gold-plated SD Express interface pads. The first lane 16 and the second lane 18 may be positioned toward an end 13 of the first side 12. The first lane 16 may be positioned closer to the end 13 than the second lane 18.

Bottlenecks created by single-channel operation in conventional memory cards can result in lag, buffering delays, and reduced system efficiency. In applications that require real-time processing, such as high-definition video streaming, data transfer limitations can lead to dropped frames, increased latency, and degraded user experience. Referring to FIGS. 1B-2, the second side 14 of the memory card 10 may include the third lane 20 disposed thereon. In some embodiments, the third lane 20 includes a plurality of SD interface pads, one or more PCIe contact pads, and/or data lines for an extended SD protocol. The third lane 20 may be positioned toward an end 15 of the second side 14. As discussed in more detail below, the third lane 20 may provide pathways for data and power transfer on the memory card 10.

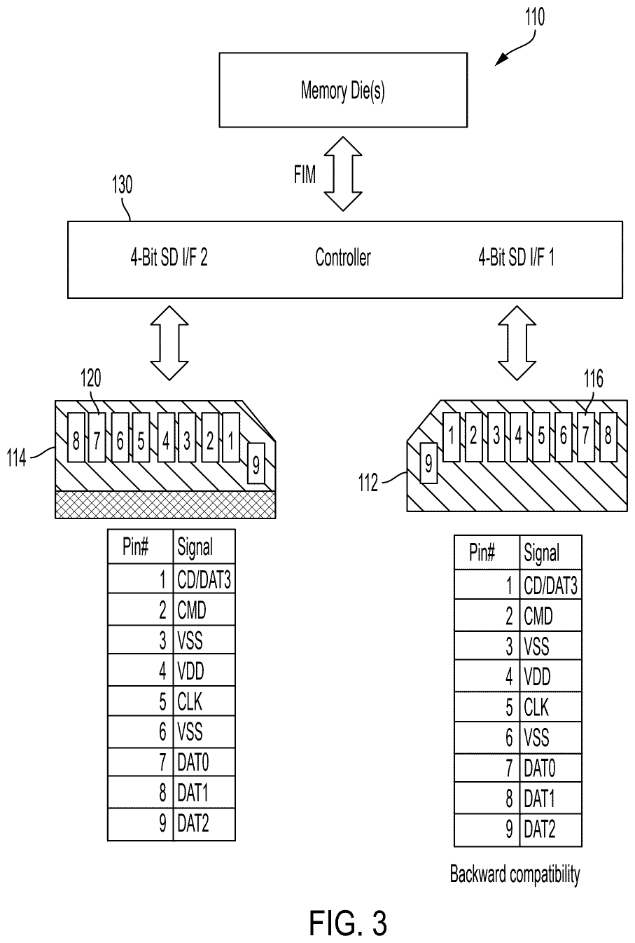

Referring to FIG. 3, there is shown a second embodiment of the memory card, generally designated 110. The memory card 110 is similar to the first embodiment of the memory card 10 except that the third lane of pads 120 may be SD interface pads, allowing the memory card 110 to function as a dual-lane SD product by enabling parallel data transfers across the two SD interfaces (e.g., first lane 116, third lane 120). In some embodiments, data transfer between the first lane of pads 116 and the controller 130 is independent of data transfer between the third lane of pads 120 and the controller 130. In some embodiments, the independent parallel data transfer to and from the controller 130 from lanes 116, 120 respectively are defined by the controller 130 and/or the electrical pathways connecting the controller 130 to the lanes 116, 120 of contact pads. The memory card 110 may communicate with a host device using two independent SD lanes, where data may be simultaneously read from or written to one or more memory dies 127 of the memory card 110. The first lane 116, located on the first side 112, may provide a primary SD interface, while the third lane 120, located on the second side 114, may function as an additional SD interface. The memory card 110 may include an internal controller 130, generally the same as controller 30, and configured to route data across both interfaces, thereby increasing overall data throughput and reducing latency compared to a conventional single-lane SD interface. The lanes 116, 120 may generally be the same as lanes 16, 20 discussed above.

The memory card 110 may be configured to operate in either single-lane or dual-lane mode, depending on the capabilities of the host device. In legacy SD sockets or card connectors (e.g., SD card readers) that do not support dual-lane communication, the memory card 110 may function using only the first lane 116, thereby maintaining backward compatibility. However, in host devices that support dual-lane operation, both the first lane 116 and third lane 120 may be activated to enable simultaneous data transfers, effectively doubling the available bandwidth. The controller 130 may be configured to automatically determine whether the host device supports single-lane or dual-lane operation and adjust its functionality accordingly. For example, in an instance where the host device includes an electrical connector that makes physical contact with the third lane 120 such that they are electrically connected, the controller 130 is configured to detect the electrical connection and enable the third lane 120. Each of the first lane 116 and the third lane 120 may be 4-bit lanes. Referring to FIG. 3, the pin layouts of first lane 116 and third lane 120 may be mirrored on the first side 112 and the second side 114, respectively. Each of the first lane 116 and the third lane 120 may include 8 pins disposed about a common axis with a ninth pin offset from the axis. The ninth pin may provide a DAT2 signal.

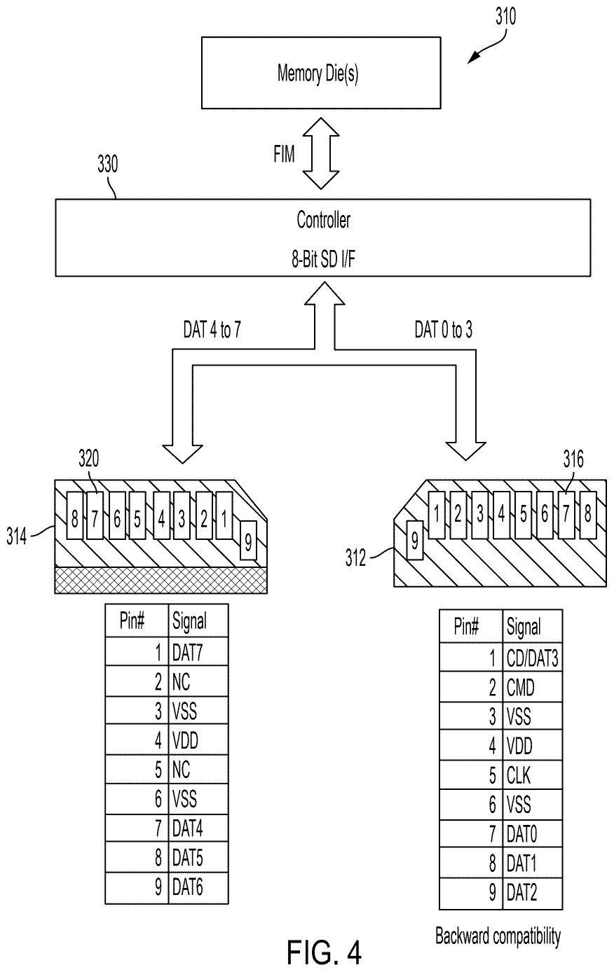

Referring to FIG. 4, there is shown a third embodiment of the memory card, generally designated 310. The memory card 310 is similar to the memory card 110 except that the third lane 320 may be extra data lines for an extended SD protocol, where four additional bits may be introduced to allow the memory card 310 to function as an 8-bit SD product, which may improve data transfer efficiency. In this configuration, the first lane 316 on the first side 312 may provide a 4-bit SD data bus, while the third lane 320 on the second side 314 may introduce an additional 4-bit data channel.

The memory card 310 may include an internal controller 330 generally the same as controller 130 and configured to coordinate simultaneous data transfers across all eight bits, ensuring synchronized communication between the memory and the host device. The memory card 310 may support both standard 4-bit SD operation and 8-bit extended SD operation, depending on the host device's capabilities. In legacy devices that only recognize a 4-bit SD interface, the memory card 310 may function using the first lane 316 alone, maintaining backward compatibility. However, in host devices designed for 8-bit SD communication, the third lane 320 may be activated, enabling full 8-bit parallel data transfer. The memory card 310 may also integrate trace routing and noise reduction to ensure reliable high-speed data transmission across all eight data lines.

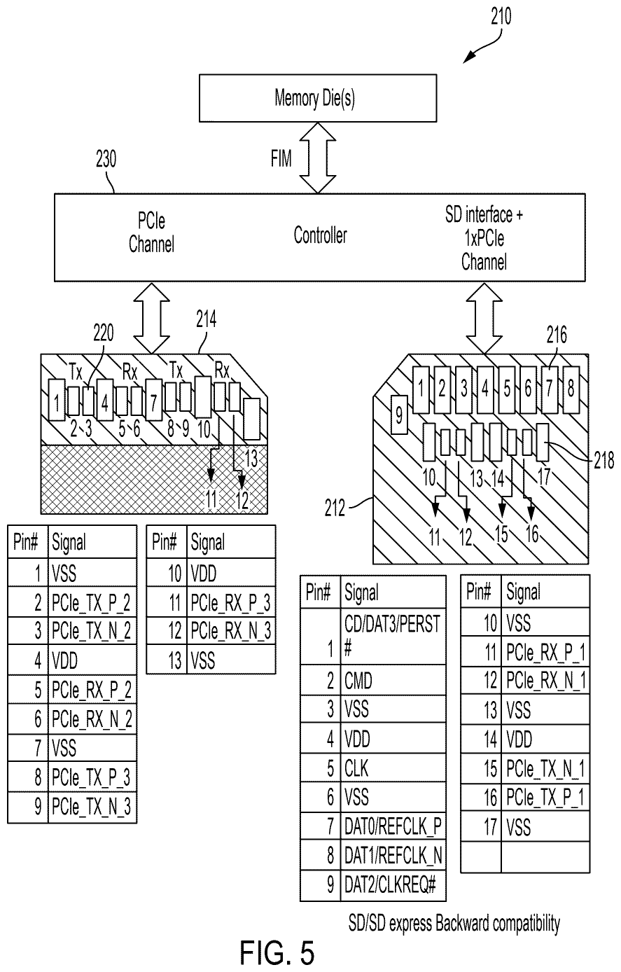

Referring to FIG. 5, there is shown a fourth embodiment of the memory card, generally designated 210. The memory card 210 is similar to the memory card 310 except that the third lane 220 may include two PCIe lanes, enabling the memory card 210 to operate as a 3×PCIe SD Express product. The first PCIe lane may be provided by the second lane 218 on the first side 212, and two PCIe lanes may be provided by the third lane 220 on the second side 214. This multi-lane PCIe configuration may allow the memory card 210 to achieve higher bandwidth and reduced latency when compared to conventional memory cards, making it particularly well-suited for applications requiring high-speed storage performance.

The memory card 210 may include an internal controller 230 capable of managing multi-lane PCIe data transmission, distributing workloads across all three lanes. The controller 230 may be configured to divide large amounts of data into smaller segments and transmit them concurrently across the three PCIe lanes, effectively tripling the data throughput.

The memory card 210 may be designed to operate in both legacy single-lane PCIe mode and multi-lane PCIe mode, depending on the host device's capabilities. In devices that only support single-lane PCIe, the memory card 210 may function using only the second pads 218 on the first side 212, maintaining backward compatibility with existing SD Express hosts. In host devices that support multi-lane PCIe SD Express, the third pads 220 may be activated. The memory card 210 may actively determine lane availability based on the host's capabilities and adjust performance accordingly.

The term “about” or “approximately” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”. Finally, unless specifically set forth herein, a disclosed or claimed method should not be limited to the performance of their steps in the order written, and one skilled in the art can readily appreciate that the steps may be performed in any practical order.

What is claimed is:

1. A memory card comprising:
a substrate having a first side and a second side opposite the first side;
a memory device coupled to one of the first and second sides of the substrate;
a first lane of contact pads and a second lane of contact pads disposed on the first side of the substrate;
a third lane of contact pads disposed on the second side of the substrate; and
a casing enclosing at least a portion of the substrate therein and having a first opening exposing the first and second lanes of contact pads and a second opening exposing the third lane of contact pads.

2. The memory card of claim 1, wherein the third lane includes at least one SD interface pad.

3. The memory card of claim 2, wherein the first lane provides a primary SD interface and the third lane provides a secondary SD interface.

4. The memory card of claim 3, wherein the memory device includes a controller configured to selectively activate at least one of the first lane and the third lane based on a corresponding interface of a host device that the memory card is connected to.

5. The memory card of claim 1, wherein the third lane includes two PCIe lanes.

6. The memory card of claim 1, wherein the second lane provides a first PCIe lane and the third lane includes a second PCIe lane and a third PCIe lane.

7. The memory card of claim 1, further comprising:
a controller configured to activate at least one of the first lane and the third lane when the memory card is connected to a host device.

8. The memory card of claim 1, wherein the third lane is disposed on the second side of the substrate in a mirrored position with respect to a position of the first lane on the substrate.

9. The memory card of claim 1, wherein the casing has a thickness of about 2.1 mm.

10. A memory card comprising:
a substrate having a first side and a second side opposite the first side;
a memory device including a memory die and a memory controller, the memory device electrically and mechanically connected to the substrate on one of the first and second sides;
a first lane of contact pads and a second lane of contact pads electrically and mechanically connected to the substrate at the first side;
a third lane of contact pads electrically and mechanically connected to the substrate at the second side; and
a casing enclosing at least a portion of the substrate and memory device therein and having a first opening at the first side exposing the first and second lanes of contact pads and a second opening at the second side exposing the third lane of contact pads.

11. The memory card of claim 10, wherein the controller is configured to selectively activate at least one of the first lane and the third lane based on a corresponding interface of a host device that the memory card is connected to.

12. The memory card of claim 10, wherein the third lane includes at least one SD interface pad.

13. The memory card of claim 12, wherein the first lane provides a primary SD interface and the third lane provides a secondary SD interface.

14. The memory card of claim 10, wherein the third lane includes two PCIe lanes.

15. The memory card of claim 10, wherein the second lane provides a first PCIe lane and the third lane includes a second PCIe lane and a third PCIe lane.

16. The memory card of claim 10, wherein the third lane is disposed on the second side of the substrate in a mirrored position with respect to a position of the first lane on the substrate.

17. The memory card of claim 10, wherein the casing has a thickness of about 2.1 mm.

18. The memory card of claim 10, wherein the memory card is a secure digital card.

19. A memory card comprising:
a substrate means for providing electrical interconnections between electrical components coupled to the substrate means;
a storage means for storing an amount of data;
a first lane of electrical contact means and a second lane of electrical contact means each for providing electrical interface between the storage and a host device, the first and second lanes of electrical contact means disposed on a first side of the substrate means;
a third lane of electrical contact means for providing electrical interface between the storage means and a host device, the third lane of electrical contact means disposed on a second side of the substrate opposite the first side; and
a casing means for enclosing at least a portion of the substrate means and storage means.

20. The memory card of claim 19 further comprising:
a memory control means for controlling operation of the storage means, the memory control means configured to selectively active the first, second and third electrical contact means based on a connection of the memory card to the host device.
